(19) United States
(12) Patent Application Publication
(10) Pub. No.: US 2008/0163093 A1
(43) Pub. Date: Jul. 3, 2008

(54) Onboard Device for Managing Data Exchanged by an Aircraft with the Ground or Other Aircraft

(75) Inventor: Didier Lorido, Plaisance Du Touch (FR)

Correspondence Address: LOWE HAUPTMAN & BERNER, LLP, 1700 DIAGONAL ROAD, SUITE 300, ALEXANDRIA, VA, 22314, US

(73) Assignee: Tales, Neuily Sur Seine (FR)

(21) Appl. No.: 11/816,621

(22) PCT Filed: Feb. 8, 2006
(86) PCT No.: PCT/EP06/50736

§ 371 Date: Aug. 17, 2007

(30) Foreign Application Priority Data
Feb. 18, 2005 (FR) 05/01693

(51) Int. Cl. G06F 3/048

(52) U.S. Cl. 715/771

(57) ABSTRACT

The invention concerns the device, on board an aircraft, of data received or exchanged without any audio communication with the ground or with other aircraft by means of a data management device provided with display means showing, in a dedicated area of an interactive multi-purpose screen, shared with the flight primary instruments and the flight management computer, a set of different windows, one (LOGON) assigned to the management of an air-ground link designed to run messages with the ground, and each of the others (CPDLC, ADS, FIS, AOC, APC) being assigned to different specialized services and a selection system (a) with constantly visible tabs in the foreground, enabling any one of the management windows to be selected and focused by means of a pointing and inputting device.

### CROSS-REFERENCE TO RELATED APPLICATIONS

The present Application is based on International Application No. PCT/EP2006/050736, filed Feb. 8, 2006 which in turn corresponds to France Application No 0501693, filed Feb. 18, 2005 and priority is hereby claimed under 35 USC §119 based on these applications. Each of these applications are hereby incorporated by reference in their entirety into the present application.

### FIELD OF THE INVENTION

The present invention relates to the management, onboard an aircraft, of the data received or exchanged without vocal step with the ground or with other aircraft.

### BACKGROUND OF THE INVENTION

The transmission of these data received or exchanged by an aircraft with the ground makes use of specialized radio-electric data links. Some of these data are exchanged with the ground by services using an aeronautical telecommunication network such as the ACRS network (“Aircraft Communications and Reporting System”) or the ATN network (“Aeronautical Telecommunication Network”. Included among these services, there are a service termed ATC (“Air Traffic Control”) reserved for data exchanges with the ground-based air traffic control, a service termed AOC (“Airline Operational Communications”) reserved for aircraft charter companies, and a service termed APC (“Airline Passenger Communications”) relating to aircraft passengers. Other data are exchanged, without vocal step, with the ground or with the other aircraft deploying in the vicinity, through an onboard collision prevention system termed ADS (“Automatic Dependent Surveillance”) which operates on the basic of the flight parameters of all the aircraft deploying in one and the same vicinity and that are provided cooperatively by each aircraft on request or automatically. Other data received without vocal step may originate from automatic digital data servers by virtue of a system termed D-ATIS (“Digital-Automatic Terminal Information Service”) belonging to ground equipment and providing the various aircraft with local flight information termed FIS (“Flight Information System”) for example, meteorology data.

These messages received or exchanged without vocal step with the ground or with other aircraft are aimed at reducing the congestion of the radiofrequency bands used for speech, at providing security for the handling of aircraft by the air traffic ground control centers while avoiding the comprehension problems inherent when articulating voice messages, at facilitating the management of charter company fleets and at allowing collision risk auto-surveillance that is independent of the aircraft crews or of the air traffic controllers.

The constant increase in the performance of aircraft makes them ever trickier to pilot and justifies the presence, in a flight deck, of an ever larger number of actuation, parameterization and visualization devices for acting on the attitude, flight parameters, engines and mechanisms of an aircraft, so as to configure and manage its radio-electric communication means and to give an account of the effects of the actions undertaken. These new datalink communication services that include the pilot in their decision processes give rise to further complexity.

To counteract the increase in the complexity of piloting, one seeks to lighten the workload of the crew of an aircraft by automating a maximum of tasks by means of equipment such as the automatic pilot termed PA (“Autopilot”) which is capable, when activated, of maintaining the aircraft in a stable configuration, the speed regulator termed AT (“Autothrottle”) capable of maintaining a constant air speed by acting on the engine settings or else the flight computer termed FMS (“Flight Management System”) capable of providing the automatic pilot or the crew with the instructions enabling a predefined flight plan to be followed. This task automation equipment also demands its actuation, parameterization and visualization devices, further increasing the number of screens, buttons and indicator lights with which a flight deck is equipped.

To simplify the architecture of a flight deck and render it more functional, the trend is to reduce the number of display screens, control levers and buttons by exploiting the possibilities offered by advances in techniques for displaying and multiplexing controls. Hence, contemporary flight decks comprise display screens that group the parameters to be displayed into large categories and one or more alphanumeric keypads for parameterizing the flight equipment together with actuation devices that fulfill the role of the control stick and rudder bar. In general, in a recent flight deck, four types of major display screens can be found:
a first type of screen termed “PFD (“Primary Flight Display”) that groups together the displays of the primary flight parameters: pitch and roll attitudes given by an artificial horizon, altitude, air speed, vertical speed,
a second type of screen termed ND (“Navigation Display”) that displays a more or less detailed navigation map showing the lateral trajectory of the flight plan remaining to be traversed under or not under the control of the FMS,
a third type of screen termed PED (“Primary Engine Display”), which may be split into SED (S for “Secondary”) depending on the number of parameters to be displayed, which groups together the displays of the flight indicators (parameters for setting the mechanical equipment of the aircraft: engines, flaps), the displays of the frequencies of the radio-navigation equipment used for guidance, for the radio-communication channels serving the speech links with the ground or other aircraft, etc.,
a fourth type of screen termed MFD (“Multifunction Display) associated with an alphanumeric keypad and playing the role of a calculator screen explaining and facilitating the parameter settings made by means of the keypad, an MFD screen and the associated keypad sometimes being termed MCDU (“Multipurpose Control Display Unit”).

More recently, it has been proposed that balls, levers or computer mice be associated with the keypads used for parameter settings and that the MFD screens be made interactive so that they can be used as a computer terminal, in particular to allow the part of the flight plan remaining to be traversed to be modified by deforming its displayed graphic. With safety in mind, it has also been proposed that the functions of the principal display screens of a flight deck be made interchangeable, all of them thus becoming interactive at a stroke.

More recently still, with display screen areas increasing, it has been proposed that the PFD, ND, PED, SED displays be amalgamated into a single screen split into quadrants of unequal magnitudes, two main quadrants being assigned to the PFD and ND displays and two auxiliary quadrants being assigned to the PED and SED displays.

As far as the datalink communication services are concerned, they are traditionally managed onboard an aircraft with the help of the MCDU equipment or with the help of specific equipment comprising their own control buttons and auxiliary display screens. American patent U.S. Pat. No. 5,329,277 gives an example of ATC service management by means of specific equipment placed at the base of the windscreen. This is not consistent with crew comfort since an item of MCDU equipment is relatively complicated to handle on account of the wide range of parameter settings that it must permit and specific equipment that is simpler to manipulate but is widely dispersed in the flight deck forces the pilot to loose time in looking at the main displays thus making it more difficult to rapidly perceive an unexpected movement in an important flight parameter.

### SUMMARY OF THE INVENTION

An object of the present invention is to improve the functionality of a flight deck by allowing the management of datalink communication services from a main interactive display screen split into several quadrants of which the main ones are assigned to the primary flight parameters, to the navigation map and to the flight indicators.

The present invention is directed an onboard device for managing the digital data exchanged, without vocal step, by an aircraft, with the ground or other aircraft within specialized services, comprising means for display on an auxiliary quadrant of an interactive screen associated with a pointing and alphanumeric data input device in the manner of the screen of a computer terminal, the display surface of said interactive screen being split into several quadrants of which the main ones are assigned to the primary flight parameters and to a navigation map and said display means showing, in an auxiliary quadrant of the interactive screen and in overlaid planes, various management windows assigned, in the one case to the management of an air-ground link intended to convey the digital data exchanged with the ground and, in the case of each of the others to a different specialized service and a tab-based selection system the tabs of which are always visible in the foreground, allowing any one of the management windows to be selected and placed in the foreground by means of the pointing and input device.

Advantageously, the display means configure management windows with three successive display levels:
a greeting level where the window considered presents various task types that may be envisaged,
a level for selecting types of action and report, request or reply message that may be envisaged for accomplishing a task type selected beforehand, and
a level for parameterizing an action and report, request or reply message selected beforehand.

Advantageously, the display means split the management windows horizontally into two information fields: an upper information field reserved for the action and message reports, and a lower information field reserved for the selection, preparation and parameterization of an action and report, reply or request message.

Advantageously, the display means configure the management windows with, at their base, a lower horizontal task bar comprising activated or unactivated actuation buttons depending on the prevailing licitness of the tasks that they govern.

Advantageously, the lower horizontal task bar comprises an actuation button triggering the execution of a task of displaying the history of the actions and messages processed from a mission start.

Advantageously, the lower horizontal task bar furthermore comprises at least one pop-up menu with rubrics activated as a function of the prevailing licitness of the tasks to which they relate.

Advantageously, the display means configure the management windows with two horizontal task bars: a first lower horizontal task bar placed at the base of the windows and a second middle horizontal task bar placed at the limit of the report field and of the selection, preparation and parameterization field, said horizontal task bars comprising activated or unactivated actuation buttons depending on the prevailing licitness of the tasks that they govern.

Advantageously, the display means configure the management windows additionally with an auxiliary information field recalling the last task performed or the next task to be performed.

Advantageously, the display means site the auxiliary information field level with the middle horizontal task bar.

Advantageously, the display means depict the action and message reports in the report field in different guises depending on their prevailing processing states: in progress, terminated or archived.

Advantageously, the display means depict the action and message reports in the report field on local display backgrounds of different colors depending on their prevailing processing states: in progress, terminated or archived.

Advantageously, the display means depict, in the selection, preparation and parameterization field of a management window placed at selection display level, a range of action and report, reply or request message captions suitable for a task type selected beforehand at the greeting level or ensuing from the greeting level when the latter authorizes only a single task.

Advantageously, the display means depict the action and report, reply and request message captions in the selection, preparation and parameterization field in different guises depending on their prevailing properties: default action or message, licit action or message at this point in the processing, illicit action or message at this point in the processing.

Advantageously, the display means depict the action and report, reply and request message captions in the selection, preparation and parameterization field as entries of different colors depending on their prevailing properties: default action or message, licit action or message at this point in the processing, illicit action or message at this point in the processing.

Advantageously, the display means depict in the selection, preparation and parameterization field of a management window placed at the parameterization display level, at least one alphanumeric data input box appropriate to the parameterization of a report, reply or request message selected beforehand at the selection display level or ensuing from the greeting level when the latter authorizes only the preparation and dispatch of a message.

Advantageously, said input box or boxes appearing in the selection, preparation and parameterization field of a management window placed at the parameterization display level are accompanied by captions defining their contents.

Advantageously, the various input boxes appearing in the selection, preparation and parameterization field of a management window when processing the set of tasks to which the relevant window gives access are placed at different positions in the selection, preparation and parameterization field so as not to overlap and to be able to be assembled by overlaying to satisfy the prevailing input box requirements.

Advantageously, the display means depict a mission registration in a caption of the aircraft mission registration report field.

Advantageously, the display means depict, during the processing of a reply to a message, a timer counting down a delay granted for the reply, as report field caption of a specialized messaging management window.

Advantageously, the display means depict a rubric recalling the task currently being executed as selection, preparation and parameterization field caption.

### BRIEF DESCRIPTION OF THE DRAWINGS

Other features and advantages of the invention will emerge from the description below of an embodiment given by way of example. This description will be offered in conjunction with the drawing in which:

a FIG. 1 shows an exemplary arrangement, in an auxiliary quadrant of an interactive and multifunction viewing screen MFD, of the overlaid management windows generated and managed by a data management device according to the invention,

FIGS. 2 to 4 show a management window termed LOGON which is generated by a data management device according to the invention and takes on various appearances depending on the operating state of an air-ground radioelectric link with the ground stations of the network that handles the digital data with the ground,

a FIG. 5 shows a management window termed: “ADS”, generated by a data management device according to the invention with the aim of managing an aircraft's onboard automatic surveillance system,

FIGS. 6 to 25 show various appearances that may be taken on by a management window termed: “CPDLC”, generated by a data management device according to the invention with the aim of managing the ATC messages exchanged between the pilot or pilots and the ground controllers,

a FIG. 26 is a diagram of the arrangement of a data management device according to the invention, within the equipment onboard an aircraft, and

FIGS. 27a and 27b show a logic chart illustrating the way in which a data management device according to the invention controls the display.

### DETAILED DESCRIPTION OF PREFERRED EMBODIMENT

To make the figures more readable, the actual proportions and colors are not complied with. Thus, the screen background is represented white in the drawings whereas it is black on a screen. The alphanumeric indications are shown as black and possibly grey in the drawings whereas they may be various colors, red, blue, green on a local background that may differ from the screen background, depending on the state of processing of the events to which they are tied.

The multifunction display screen MFD shown in FIG. 1 is an interactive screen associated with an alphanumeric data input and pointing device having a keypad, ball, mouse, handle, thumbwheel, touch-sensitive surface or the like, in the manner of a computer terminal screen. The pointing and input device may be incorporated, in full or in part, into the surface of the MFD screen which is split into four main quadrants. The two left quadrants, of bigger area than the right quadrants, are reserved for the primary flight instruments in the case of the upper quadrant and for the navigation map in the case of the lower quadrant. The two right quadrants of smaller area are reserved for the radio-navigation instruments and for the flight indicators in the case of the upper quadrant, and for managing the “datalink” communication services in the case of the lower quadrant.

The primary flight instruments shown in the upper left quadrant of the MFD screen include an attitude indicator or artificial horizon 1, flanked on the right by an altimeter having a scrolling vertical linear scale 2 and with a vertical speed indicator having a vertical linear scale 3, and on the left by an air speed indicator having a scrolling vertical linear scale 4. Various alphanumeric indications placed above and below the primary flight instruments advise as to the operating mode of the automatic pilot.

The navigation map 5 shown in the lower right quadrant of the MFD screen advises as to the instantaneous geographical position of the aircraft, the risks of ground collision due to the relief overflown and the configuration of the horizontal trace 6 of the part of the flight plan remaining to be performed. This trace 6 can be graphically deformed by the aircraft crew by means of conventional drag and drop operations carried out on its points displayed on the screen by means of the pointing and input device. The navigation map 5 is crowned by a half-moon heading indicator 7 and supplemented with alphanumeric indications relating to navigation such as the identity of the next waypoint, its distance, the destination airport, etc.

The upper right quadrant of the MFD screen is subdivided into several sub-quadrants dedicated, a first one 8 to the identifications of the radio-communication mode and frequencies used in speech, a second one 9 to the identification of the ATC or ACARS network ground station used for the messagings and the automatic or nonautomatic touchdown mode, and a third one 10 dedicated to the flight and engine indicators, etc., and more generally to the indicators showing the deviation of a momentarily important parameter from its instruction value, here, a nose-up scale 11.

The lower right quadrant pinpointed by a circle 12 is a single display space grouping together the management of all the digital messages exchanged by the aircraft with its environment, the ground or other aircraft in such a way as to facilitate pilot access to this information. In the example described, the digital data managed are assumed to be those of the CPDC, AOC, APC datalink communication services exchanged with the ground-based air traffic controls and the ground-based management centers of charter companies by way of a ground relay station belonging to an aeronautical telecommunication network such as, for example, the ACARS network or the ATN network, and those of the ADS communication service devoted to messaging exchanged with other aircraft within the context of an automatic in-flight collision prevention system. The example described also supports data exchange between aircraft via air-air links of ADS-B type through Transponder type equipment (extended Squitter) or the like.

This display space of the lower left quadrant of the MFD screen is occupied by various overlaid management windows assigned in one case “LOGON” to the management of an air-ground link intended to convey the digital traffic with the ground and, in the case of each of the others, to specialized datalink communication services, such as “CPDLC”, “ADS”, “FIS”, “AOC” and “APC”. An extension tab (“ . . . ”) may possibly be defined in such a way as to support any datalink communication service and to give the system an upgrade capacity. Each of these management windows may be brought into the foreground by virtue of a row a of keys for selecting types of tabs that are always visible, selectable and actuatable by means of the pointing and input device.

These management windows exhibit several display levels: a first greeting level that gives the crew of the aircraft a choice between various types of tasks: reply to a message received, situation report, request or the like, a second selection level presenting the range of actions, reports or requests available for accomplishing a task type determined beforehand and a third level for parameterizing the type of action, report or request chosen at the second selection level.

In their various display levels, the management windows are generally split horizontally into two information fields of comparable areas: an upper field b reserved for event reports, and a lower field c reserved for selecting or preparing and parameterizing an action, report or request. At their base they exhibit a horizontal task bar d possibly supplemented, at the separation of the report field b and selection and parameterization field c, with a second horizontal task bar e, and an auxiliary field f reserved for signaling the last event achieved or the next to be achieved, and placed level with one of the task bars.

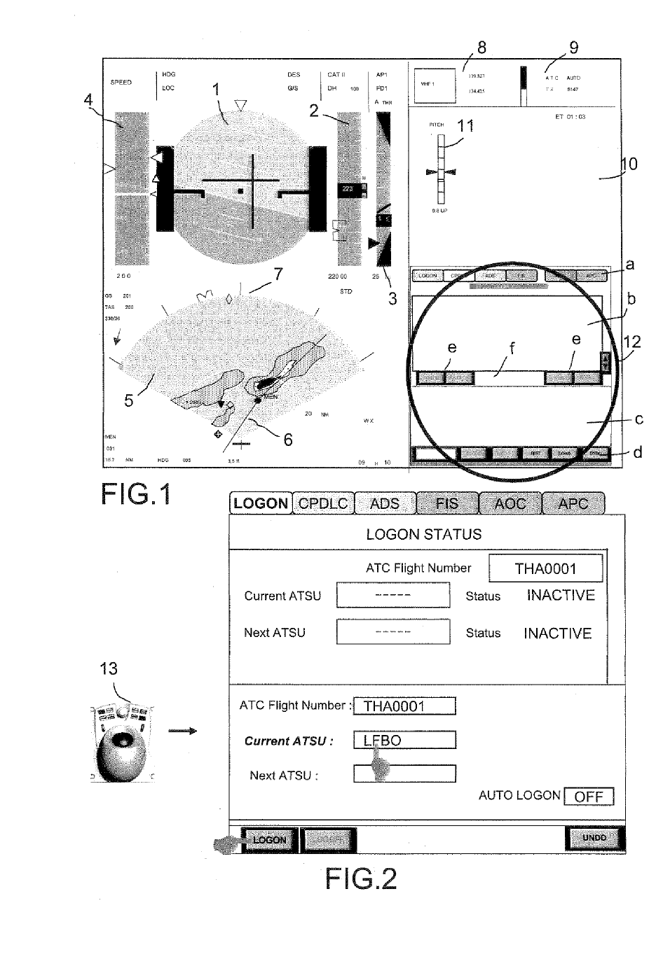

The window called by the “LOGON” tab, various guises of which are shown in FIGS. 2 to 4, serves as man/machine interface for managing the air-ground digital link that has to link the aircraft to a digital telecommunications ground station for data exchanges within the services (CPDLC, ADS, FIS, AOC, APC, . . . ). It is equally adapted for the AFN procedures (the acronym deriving from the English expression: “Air traffic Facilities Management”) for managing an air-ground link within the context of an aeronautical telecommunication network of ACARS type and for the LOGON procedures (term originating from the English expression: “log on”) for managing an air-ground link within the context of the ATN aeronautical network. It advises regarding the states of the link: currently being established, established, currently being disconnected or not established, as to the identity of the ground station concerned and as to the use or otherwise of an automatic link establishment search procedure.

The single task bar here comprises three actuation keys, a “LOGON” key triggering a manual air-ground link initialization procedure, a “LOGOFF” key terminating an air-ground link or terminating an air-ground link initialization procedure and an “UNDO” key that engages an action for returning to the state prevailing before the last action engaged but not completed.

The report field of a LOGON window can take the caption “LOGON STATUS”. It mentions the nature, ATC or ACARS, of the network to which the relevant ground stations belong and logs the registration of the mission fulfilled by the aircraft: “Flight Number”, the identifiers of any ground station contacted “Current ATSU” and of any next ground station to be contacted “Next ATSU” when the aircraft leaves the control zone of the ground station contacted “Current ATSU”, as well as the actual statuses of the links with these ground stations.

In the embodiment described, the greeting and LOGON window selection display levels give way to the parameterization display level which is accessed directly. However, it would be possible to directly access the selection display level which would give, in the selection and parameterization field, the identifiers of the various contactable ground stations, supplemented with an empty identity enabling the crew to make a different choice from those proposed and to go to the parameterization display level only after selecting one of the proposed identifiers.

In the absence of a link established beforehand at the instigation of an air traffic control ground station or at the instigation of the aircraft's crew if the aircraft's communication medium so permits, the selection and parameterization field of a LOGON window displays, as shown in FIG. 2, a questionnaire with captions: “ATC Flight Number”, “Current ATSU”, “Next ATSU” and “AUTOLOGON” that the crew of the aircraft fills in by means of the pointing and alphanumeric data input device 13.

The “FLIGHT NUMBER” caption is distinguished from the others by its font symbolism (specific color or characters) to show that it is the only one to have to be filled in (automatically or manually) to establish a datalink link. Once the caption of the ground station to be contacted and, possibly, the captions of the next ground station to be contacted have been filled in, the crew can actuate the “LOGON” key of the lower task bar in order to enable the procedure for establishing the link with the chosen ATC center. The automatic procedure for establishing a link with an ATN center that is preconfigured or automatically selected on the basis of the current position of the aircraft is active if the “AUTO LOGON” field is active.

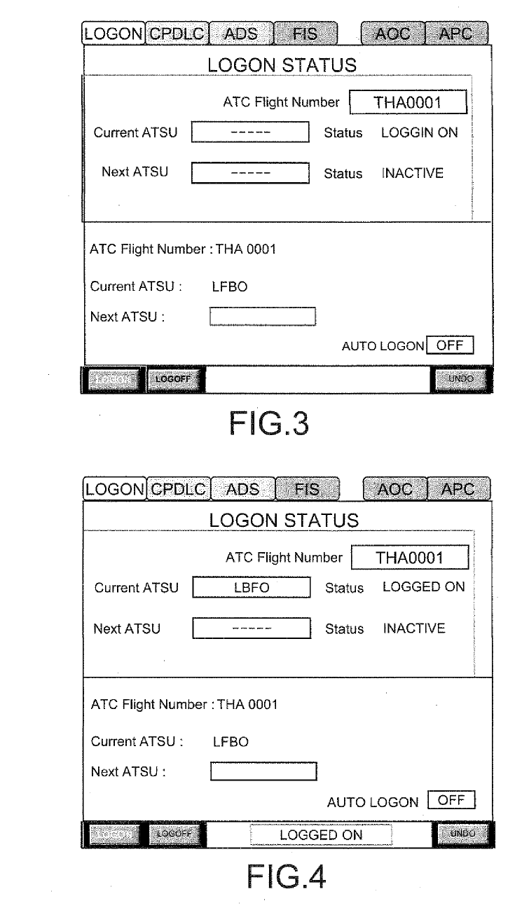

Actuation of the LOGON key of the lower task bar or the AUTOLOGON automatic procedure triggers a procedure for initializing an air-ground link with the designated ground station. The LOGON window then takes on the appearance of FIG. 3 (in the case of a manual LOGON), the status of the ground station “Current ATSU” being transformed into “LOGGING ON” in the report field and the “ATC Flight Number” and “LFBO” captions becoming nonmodifiable in the selection and parameterization field.

As soon as an air-ground link has actually been established with the designated ground station, the LOGON window takes on the appearance of FIG. 4, the identity of the designated ground station appearing in the report field opposite the “Current ATSU” caption, the status of the ground station “Current ATSU” being transformed into “LOGGED ON” and the words “LOGGED ON” also appearing in the auxiliary signaling field placed level with the single lower task bar. The frozen fields become modifiable again should the link be disconnected via the LOGOFF key or following a break in the Air-Ground link. The link is reestablished automatically if the AUTOLOGON field is activated.

The window called by the “ADS” tab, the appearance of which is shown in FIG. 5, serves as man-machine interface for enabling or disabling an automatic in-flight or ground accident and incident prevention system. This system, termed ADS, compares the aircraft's position, given by its flight equipment, with the positions that the other aircraft deploying in its vicinity communicate to it on request or systematically via digital radio-transmission links. It periodically reports, to the ground controller, information extracted from the aircraft's navigation systems allowing dynamic control of the flight plan. It will not be described since it does not form part of the invention and is well known to the person skilled in the art of flight management.

As in the case of the LOGON window, the greeting and selection display levels give way to the parameterization level. The ADS window (FIG. 5) presents a single task bar in its lower part. The latter comprises three actuation keys: an alarm key “ADS EMERG” causing the ADS system to send distress messages bound for the vicinity of the aircraft, other aircraft present in its zone of deployment and/or for the air traffic control center in charge of the aircraft, a key for cancelling the alarm “CANCEL EMER” and a key “UNDO” that engages an action for returning to the state prevailing before the last action engaged.

The report field of the ADS window can take the caption “ADS STATUS”. It mentions the actual states, active or inactive, of the ADS system and of its part that generates the distress messages.

The ADS window selection and parameterization field presents a questionnaire with the caption “ADS mode” and just two possible replies OFF or ON authorized by a logic switch 14 manipulated with the help of the pointing and input device 13.

FIG. 5 shows the appearance of the ADS window in the commonest case where the ADS system is activated but is not dispatching a distress message.

The management window, called by the FIS tab, serving for the reception of the information about local flight conditions sent in the form of digital data by D-ATIS automatic servers belonging to the ground equipment, as well as the management window called by the AOC tab that serves as man/machine interface for the AOC service reserved for charter companies and the management window called by the APC tab, that serves as man/machine interface for the management of messaging for use by the passengers are designed around the same model as the LOGON, ADS management windows already described and as the CPDLC management window which will be described in detail subsequently.

As in the case of the LOGON, ADS or CPDLC management windows, the FIS, AOC, APC management windows possess three display levels: a greeting level, a selection level and a parameterization level that are able to give way to one another. At each display level, greeting, selection or parameterization, the FIS, AOC, APC management windows present two fields of similar areas dividing them horizontally: an upper field reserved for event reports and a lower field reserved for action selections and for parameterizations, a lower horizontal task bar possibly supplemented, if need be, with a second task bar placed at the separation between the report field and the selection and parameterization field, and an auxiliary field reserved for signaling the last event achieved or the next one to come situated level with one of the task bars, the contents of the fields and task bars being adapted to the needs of these services.

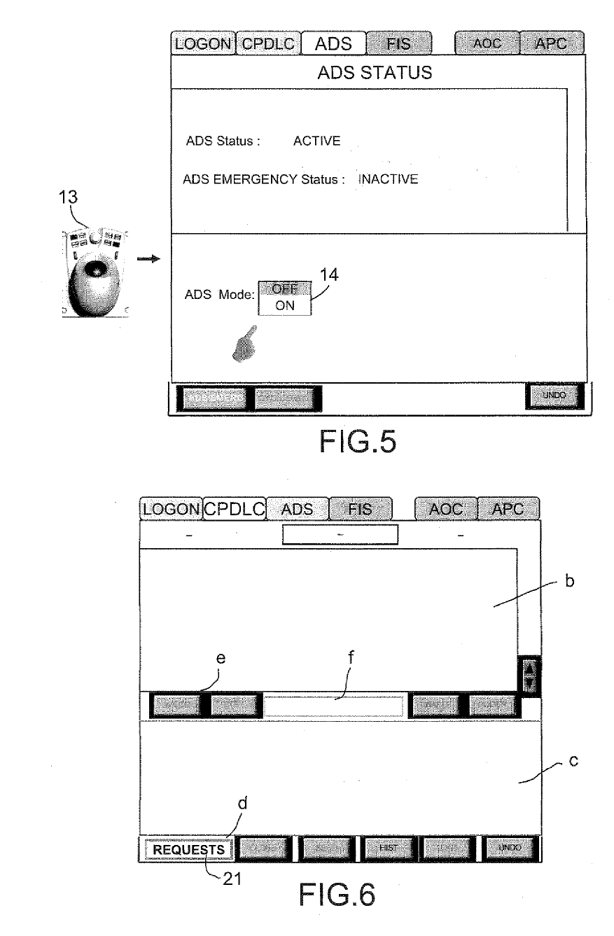

FIGS. 6 to 25 show various appearances that may be taken on by the management window called by the “CPDLC” tab which serves as man/machine interface for the standardized messaging exchanged, within the CPDLC service, between the aircraft and the air traffic control ground centers.

This CPDLC window, still on the same model as the previous ones, presents two fields of similar areas that split its area horizontally: an upper report field b and a lower action and parameterization selection field c, a first horizontal task bar d at its base, a second task bar e at the boundary between the upper field b and lower field c, and an auxiliary field f for signaling the last task achieved, encroaching on the second task bar e.

At its left end, the first lower task bar d comprises a task selection pop-up menu 21, that has popped up in FIG. 10, corresponding to the various tasks that can be executed in the course of the CPDLC service, in fact three modes for managing messages with an air traffic control ground station: the “REQUESTS” mode for a request, that is to say a request on the initiative of the crew of the aircraft, the “REPLIES” mode for a reply of the aircraft's crew to an air traffic control ground station request, and the “REPORTS” mode for a flight condition related report made by the crew of the aircraft, on their own initiative. The first lower task bar d continues towards the right with five actuation keys: a “CLOSE” key for archiving a message exchange, a “SEND” key for sending a message, a “HIST” key for recalling the history of archived messages, a “LOAD” key for loading an instruction into or from the aircraft's flight management computer and an “UNDO” key engaging an action for returning to the state prevailing before the last action engaged. This first lower task bar d also comprises, as will be seen hereinafter, other pop-up menus that appear, when the need to parameterize an action makes itself felt, above the actuation keys that are inactive by virtue of the context.

The second middle task bar e comprises four actuation keys corresponding to the commonest standardized replies: a “WILCO” key (the abbreviation of the English term: “Will Comply”) for acknowledging receipt with acceptance of the instruction received from the ground-based air traffic control, a “STBY” key (abbreviation of the English term: “Stand by”) for acknowledging receipt of an instruction from the ground-based air-traffic control on standby awaiting consideration, an “UNABLE” key for acknowledging receipt of an instruction from the ground-based air traffic control with a refusal of the instruction due to impossibility of execution and a “ROGER” key for straightforward acknowledgment of receipt with no indication as to the return reply.

FIG. 6 shows the CPLC management window greeting display level, which is the one appearing after a link has been established and before any message has been received from or sent to an air traffic ground control center. The report field and selection and parameterization fields are empty and the two task bars have just one active key, the “HIST” key, the other inactive keys are signaled through specific symbolism (here, shaded). The pop-up menu on the left of the first task bar is on the “REQUESTS” caption which represents the default message management mode.

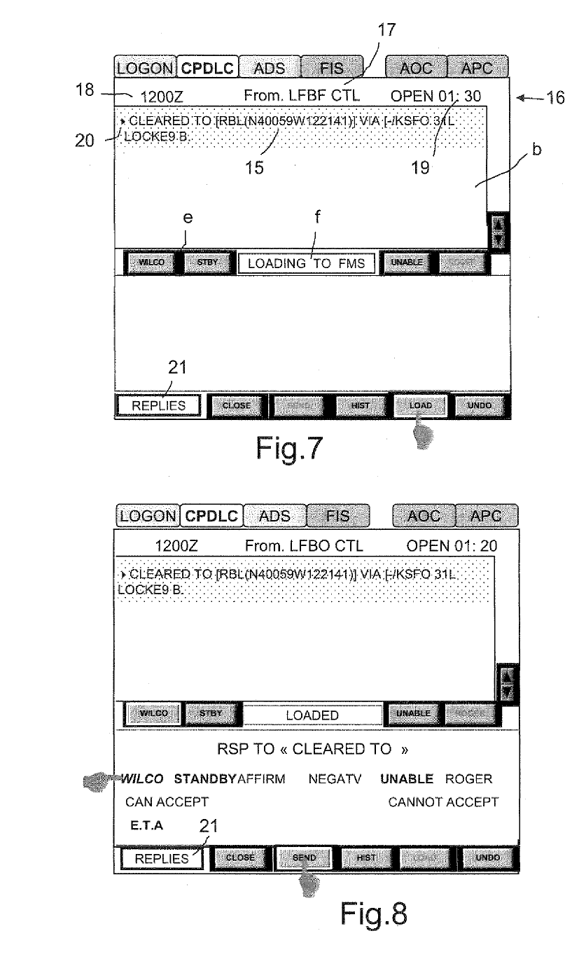

FIG. 7 shows the guise in which the CPDLC management window appears, still at its greeting level, on receipt of a message originating from an air traffic ground control center. The message 15, here an authorization to proceed to a determined position while passing through a prescribed waypoint, is displayed in the report field b underneath a banner 16, that encloses in the middle position 17, the sign of the air traffic control ground station that sent the message, on the left-hand side 18, the universal time and, on the right-hand side 19, the “OPEN” state of the dialog with a timer counting down a time allotted for the reply.

The local background motif on which the message received appears, which is in reality a green color, shows that the message is active, that is to say that the actuation keys available on the task bar relate to actions pertaining to this message. It is pointed out that only the start of the message is displayed so as to save space. However, the message may be displayed in its entirety. This is signaled by the orientation taken by a specific marker 20 placed at the start of a line, which orientation may be changed by means of the pointing and input device 13.

The three keys of the middle task bar corresponding to the three most common possible standardized replies for the crew: “WILCO”, “STBY”, “UNABLE” can be actuated as a function of the context, as can the “CLOSE”, “LOAD” and “UNDO” keys of the lower task bar. Furthermore, the “REPLIES” caption appears on the left in the task selection menu 21 of the lower task bar. This menu may pop up since the crew of the aircraft is authorized to enter the “REQUESTS” or “REPORTS” message management modes in order to exploit the existence of an established link with the air traffic control ground station if the need to send a message uncorrelated with that received makes itself felt.

The message received may possibly be loaded automatically into the aircraft's navigation system using the LOAD button. In such a case, the auxiliary signaling field f displays the status of the task “LOADING FMS” in progress. This task, which is the loading of the routing instruction into the flight management computer, causes the CPDLC management window to change appearance and to take on the guise of FIG. 8 as soon as it is accomplished (“LOADED”).

The request to input a reply to the message received by selecting the “REPLIES” rubric of the pop-up menu 21 or one of the buttons of the task bars e, d causes the CPDLC management window to go to the selection display level. The action and parameterization selection field is filled in, under the message reply caption, with an inventory of permitted replies allowed in a messaging of the CPDLC service with, shown bold but in actual fact colored green, the authorized standardized replies which are the only ones to have any meaning in the present situation and, shown in bold italics, but, in actual fact, in white on a green background, the default reply here “WILCO”. The crew of the aircraft may be satisfied with the default reply or modify it by activating another reply, here “STAND BY”, “UNABLE” or E.T.A. (the abbreviation for the English expression: “Estimated Time of Arrival”) by means of the pointing and input device 21. The newly activated reply becomes the default reply, its representation becoming bold italics whereas the representation of the former default reply becomes simply bold.

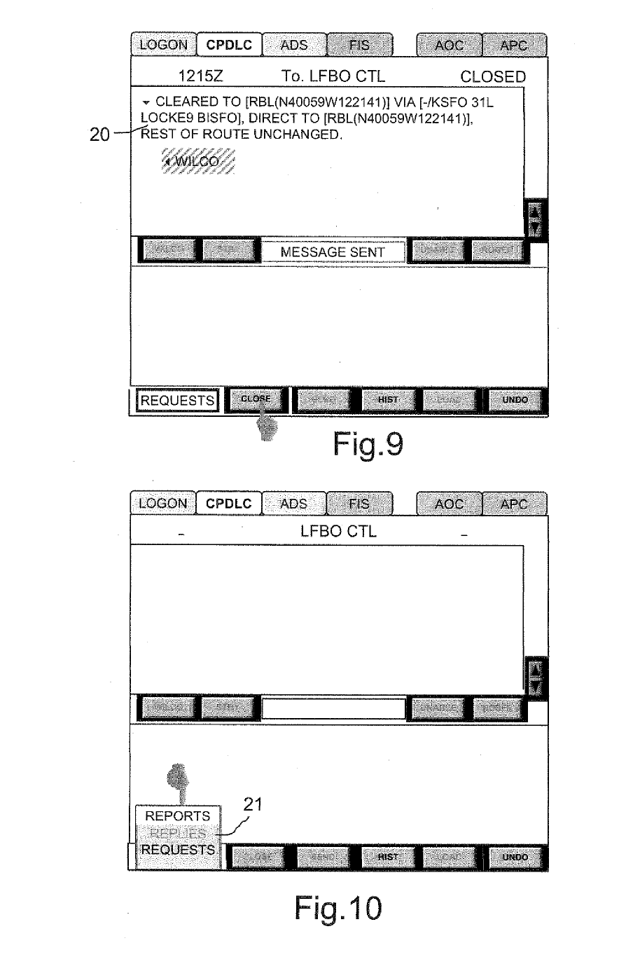

The crew of the aircraft, after having chosen the reply in the action and parameterization selection field, forwards it to the air traffic control ground station by actuating the “SEND” key of the lower task bar. In this case, the auxiliary field f will display “SENDING MESSAGE” while the reply is being sent, and then “MESSAGE SENT” immediately after acknowledgement of the reply received from the Ground by the system. The CPDLC management window then reverts to its greeting display level, its report field being supplemented, as shown in FIG. 9, with the reply made displayed, on a particular background motif, in actual fact a bright blue color signifying that the dialog is closed. Automatic indentation also makes it possible to follow the sequencing of the message exchanges between the aircraft and the Ground.

It is noted moreover that, in the banner 16 of the report field, the state of the dialog goes to “CLOSED” with the disappearance of the timer counting down the reply time and that the pop-up task selection menu 21, on the left of the lower task bar, again displays the “REQUESTS” message default management mode. The action and parameterization selection field is cleared and the auxiliary signaling field displays the words “MESSAGE SENT”.

Here, the message 15 is displayed in full in the report field. This is signaled by the orientation of its specific start-of-line marker 20, which has changed. A recessed tabulation conveys the dependency on the message of the reply made.

The crew of the aircraft have now merely to actuate the “CLOSE” button of the lower task bar to archive the dialog relating to the message received. Archiving consists in placing the message and the reply made in memory for possible consultation during a history search. The CPDLC management window reverts to its greeting display level in the state shown in FIG. 6.

When the crew of the aircraft wish to send, on their own initiative, a message pertaining to one of the flight parameters thereof bound for an air traffic control ground station with which they have a link, they point to the pop-up task selection menu 21 of the lower task bar of the CPDLC management window by means of the pointing and input device 13, thereby causing this menu to open as shown in FIG. 10, and activating one of the rubrics present: “REPORTS” or “REQUESTS”, the “REPLIES” rubric being inactive on account of the absence of any message received pending reply.

The activation of a “REPORTS” or REQUESTS rubric makes it possible to switch the CPDLC management window to the selection display level. In this level, the captions of various kinds of reports bound for the air traffic control ground station that are permitted in respect of the activated rubric appear in the action and parameterization selection field. The number of kinds of reports is not limited by the area of the action and parameterization selection field, it being possible to use an extension mechanism obeying a “MORE>” key to scroll additional reports pages. The report field of the CPDLC management window is empty since no message has yet been sent. The keys of the middle task bar are all inactive since none of them corresponds to the message to be sent. In its lower task bar, the “LOAD” and “SEND” keys are inactive, the “LOAD” key because it is inappropriate for the process triggered and the “SEND” key because the message to be sent is not yet ready.

FIG. 11 gives an example of the guise in which the CPDLC management window may appear when the crew of the aircraft has taken the initiative to activate the “REPORTS” rubric of the pop-up task selection menu 21 of the lower task bar. This CPDLC management window, which has switched to the selection display level, displays, in its action and parameterization selection field, five report captions relating to the flight altitude of the aircraft: “PRESENT LEVEL”, “MAINTAINING LEVEL”, “ASSIGNED LEVEL”, PREFERRED LEVEL” and “TOP OF DESCENT”, and an “E.T.A.” report caption relating to an estimated time of arrival. The “SPARE” rubric is there to show that other report captions may be displayed and the “MORE>” rubric to show that there may be several successive pages of report captions. The report caption pointed at by the crew by means of the pointing and input device 13 changes appearance so that it stands out better. In FIG. 11, the report caption pointed at, which is “MAINTAINING LEVEL”, appears in bold italics whereas it is in actual fact white on a green background. The other captions are simply bold whereas they are in actual fact green.

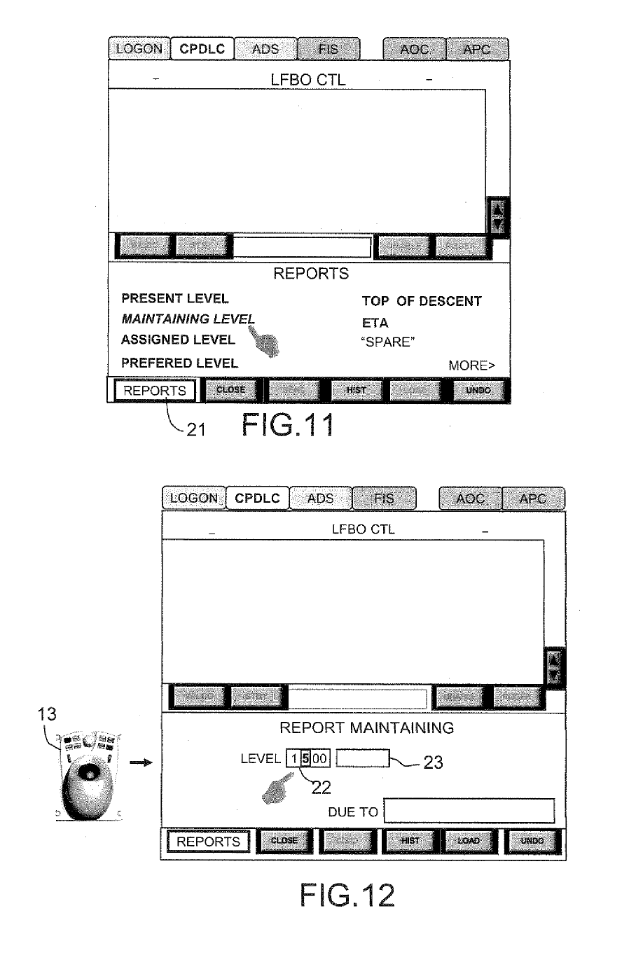

As shown in FIG. 12 for the selection of the “MAINTAINING LEVEL” report caption, the selection of one of the report captions relating to the flight altitude of the aircraft causes the CPDLC management window to switch to the parameterization display level. In this parameterization display level, the action and parameterization selection field presents, under a banner recalling the activated rubric “REPORT” and the chosen report caption “MAINTAINING”, opposite a “LEVEL” rubric, a number input box 22 and a distance unit input box 23 which may be selected and filled in by means of the pointing and input device 13.

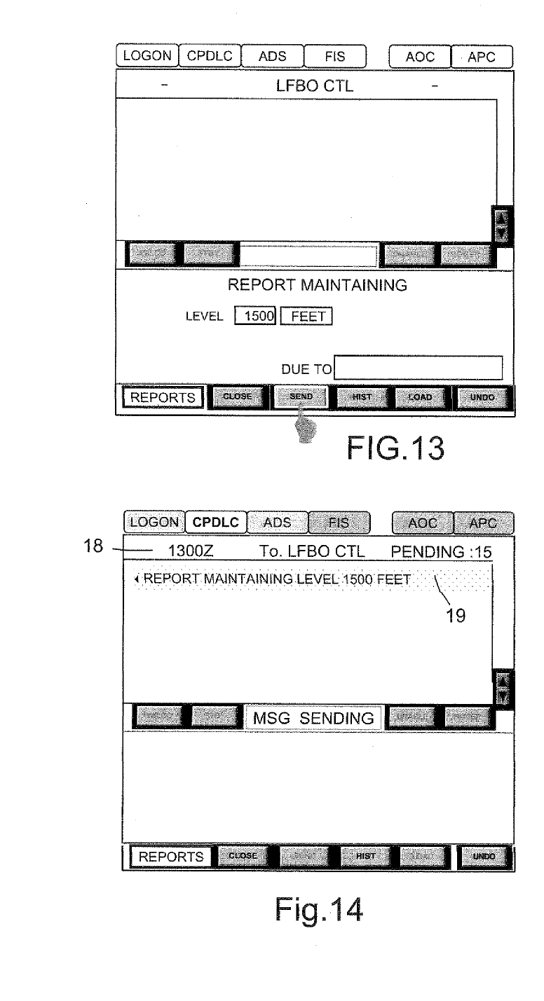

Once the compulsory input box 22 has been filled in (the fact that input is compulsory being indicated through specific symbolism), the “SEND” key of the lower task bar of the CPDLC management window reactivates as shown in FIG. 13 so that the crew of the aircraft can, by actuating this key, send the message to the air traffic control ground station with which they have a link. The actuation of the “SEND” key causes, as is shown in FIG. 14, the CPDLC display window to switch to its greeting display level while, in the report field, mentioning the message currently being transmitted on a background motif, in actual fact a green colored background, showing that it is active, that is to say that the actuation keys available on the task bars relate to actions pertaining to the reply to this message, and while mentioning at 18 the local time and at 19 the state of the transmission operation and the countdown of the period granted for carrying out this transmission operation. The display of the wording “MSG SENDING” appears in the auxiliary display field. The action and parameterization selection field is cleared.

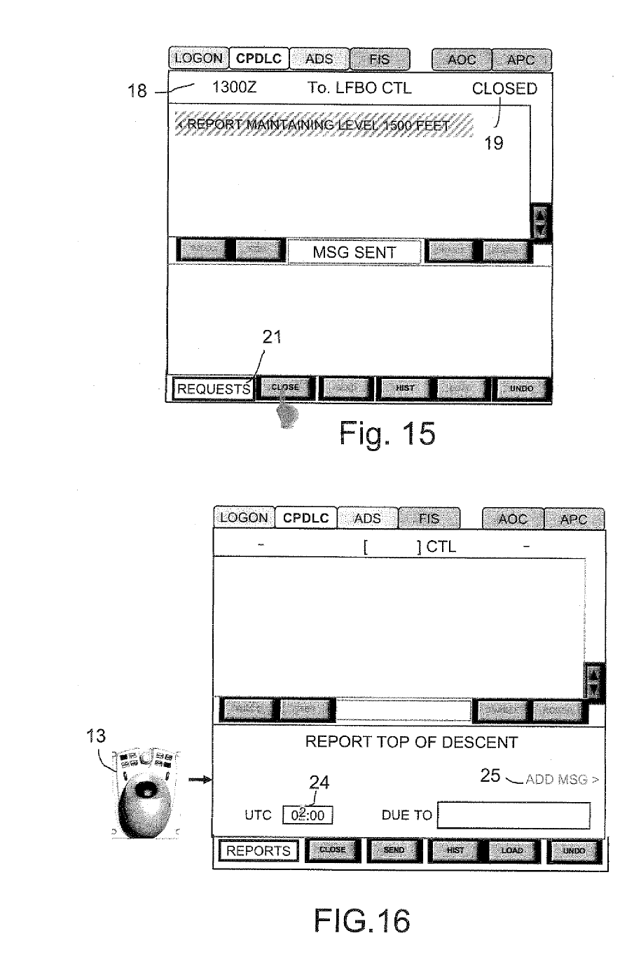

After actual transmission, and as shown in FIG. 15, the background motif for displaying the message in the report field changes appearance, in fact the display background takes on a bright blue color signifying that the dialog is closed. Still in the report field, the word “CLOSED” replaces the word “PENDING” and the countdown to signify that the system is not waiting for any action by the crew. Finally, the “MSG SENT” message appears in the auxiliary display field and the “REQUESTS” default message management mode in the pop-up menu 21 on the left of the lower task bar.

The actuation of the “CLOSED” button of the lower task bar then makes it possible to archive the dialog relating to the message, this causing the message to be stored for possible consultation during a history search and the CPDLC management window to resume the initial appearance of its greeting display level shown in FIG. 6.

The selection of the “TOP OF DESCENT” report caption instead of the “MAINTAINING LEVEL” report caption also causes the CPDLC management window to switch to a parameterization display level but with the appearance of FIG. 16. Its action and parameterization selection field begins to display, under a banner recalling the caption of the activated rubric “REPORT” and the chosen kind of report “TOP OF DESCEND”, a time input box 24 opposite a “UTC” caption (the abbreviation standing for the English expression: Coordinated Universal Time). An activatable key captioned “ADD MSG” 25 enables other reports to be added to the message under preparation.

The time input box 24 is selected and filled in by means of the pointing and input device 13.

As in the case of FIG. 12, the “SEND” key of the lower task bar of the CPDLC management window reactivates as soon as the compulsory input box 24 has been filled in so as to afford the crew of the aircraft the possibility, by actuating this key, of sending, to the air traffic control ground station with which the aircraft has a link, the report or reports once they have been finalized. It should be noted that the UTC data item required could, at this juncture, be downloaded automatically from the aircraft's navigation system through the LOAD key, thus significantly lightening the pilot's task.

In the same way as for any other report, the actuation of the “SEND” key causes the CPDLC management window to return to its greeting display level with the display in the report field, of the message currently being transmitted on a background motif, in actual fact a green colored background, showing that it is active, of the local time, of the state of the transmission operation and of the countdown of the period granted for carrying out this transmission operation, with display of the wording “MSG SENDING” in the auxiliary display field and with erasure of the action and parameterization selection field.

After transmission, the display of the message in the report field changes appearance, its background motif taking on a bright blue color signifying that the dialog is closed. The wording “MSG SENT” appears in the auxiliary display field. The actuation, finally, of the “CLOSE” button of the lower task bar makes it possible to archive the dialog relating to the message, this causing the message to be stored for possible consultation during a history search and the CPDLC management window to resume its greeting display level with the appearance shown in FIG. 6.

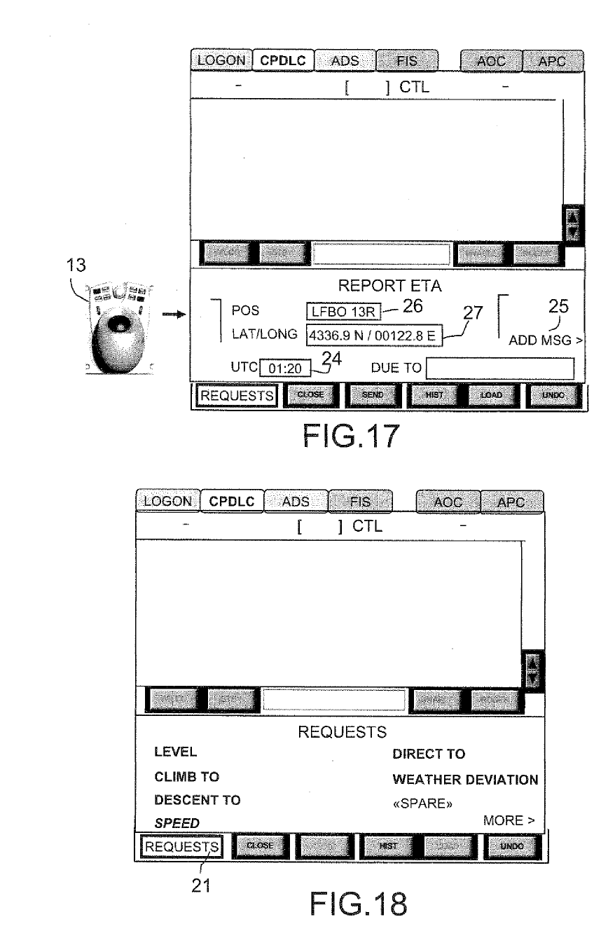

The selection of the “ETA” (estimated time of arrival) report caption instead of the “TOP OF DESCENT” or “MAINTAINING LEVEL” report captions also causes the CPDLC management window to switch to a parameterization display level but with the appearance of FIG. 17. Its action and parameterization selection field begins to display, under a banner recalling the caption of the activated rubric “REPORT” and the kind of report chosen “ETA”, the time input box 24 opposite a “UTC” caption and the “ADD MSG” activatable key 25, overlaid with a box 26 for inputting the identity of the waypoint concerned, preceded by the caption “POS”, and a box 27 for inputting the coordinates of the waypoint concerned, preceded by the caption “LAT/LONG”.

The various input boxes 24, 26, 27 are selected and filled in by means of the pointing and input device 13. The two boxes 26, 27 for inputting identity and coordinates of the waypoint concerned are tightly linked and filling one of them in may cause the other to be filled in automatically when the flight management computer of the aircraft has the waypoint concerned in memory. The box 26 for inputting the identity of the waypoint concerned might not be filled in if the box 27 for inputting its coordinates is.

In the same way as for any other report message, the actuation of the “SEND” key causes the CPDLC management window to return to its greeting display level with the display in the report field, of the message currently being transmitted on a background motif, in actual fact a green colored background, showing that it is active, of the local time, of the state of the transmission operation and of the countdown of the period granted for carrying out this transmission operation, with the display of the wording “MSG SENDING” in the auxiliary display field and with erasure of the action and parameterization selection field.

After transmission, the display of the message in the report field changes appearance. Its background motif, in fact the display background, takes on a bright blue color locally, signifying that the dialog is closed. Moreover, the wording “MSG SENT” appears in the auxiliary display field. The actuation, finally, of the “CLOSE” button of the lower task bar makes it possible to archive the dialog relating to the message, this causing the message to be stored for possible consultation during a history search and the CPDLC window to resume its greeting display level with the appearance shown in FIG. 6.

FIG. 18 gives an example of the guise in which the CPDLC management window may appear when the crew of the aircraft takes the initiative to make a modification authorization request for one of its flight instructions to an air traffic control ground station with which they have a link, either because the link has been opened beforehand by the ground station so as to send a message to which they have replied and has not been explicitly closed, or because the crew of the aircraft has opened the link after executing a link initialization procedure conducted in conjunction with the LOGON management window. The crew has pointed, in the CPDLC management window, while it was at its greeting display level, at the pop-up task selection menu 21 of the lower task bar, this having caused it to open. They have then activated the “REQUESTS” rubric causing the CPDLC management window to switch to the selection display level shown in FIG. 18.

The action and parameterization selection field presents three captions of requests relating to the flight altitude of the aircraft: “LEVEL”, “CLIMB TO”, “DESCEND TO”, a “SPEED” request caption relating to a speed, a “DIRECT TO” request caption relating to the destination and a “WEATHER DEVIATION” request caption for modifying the flight plan on account of uncertain weather. It also comprises a “SPARE” rubric showing that other request captions may possibly be displayed and a “MORE>” rubric showing that there may be several successive pages of request captions. As in any selection display level, the request caption pointed at by the crew changes appearance so as to stand out better. In FIG. 18, the request caption pointed at, which is “SPEED”, appears in bold italics whereas it is in actual fact white on a green background. The other captions are simply bold whereas they are in actual fact green.

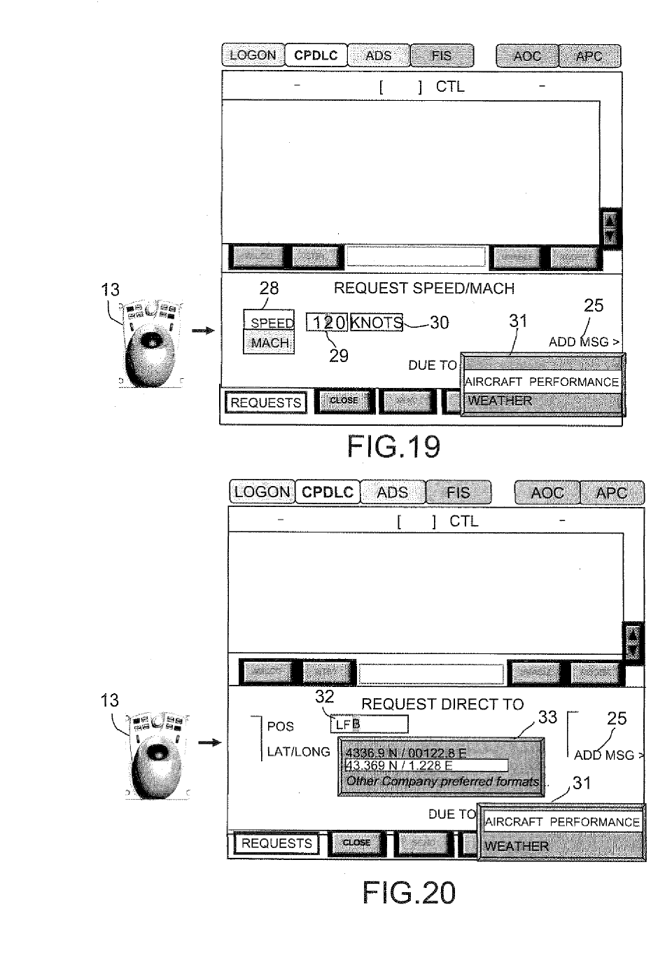

The selection of the “SPEED” request caption causes the CPDLC window to switch to a parameterization display level with the appearance of FIG. 19. Its action and parameterization selection field begins to display, under a banner recalling the caption of the activated rubric “REQUEST” and the kind of request chosen “SPEED/MACH”, a “SPEED” or “MACH” caption input box 28 behaving in the manner of a pop-up menu, a speed value input box 29, a speed units input box 30 also behaving in the manner of a pop-up menu, a box 31 for inputting justificatory grounds preceded by the caption “DUE TO” and behaving in the manner of a pop-up menu with one of its captions empty and the “ADD MSG>” activatable key 25 already encountered during parameterization of the reports.

The various input boxes 28, 29, 30, 31 are selected and filled in by means of the pointing and input device 13.

In the same manner as for the reports made during the selection of the “REPORTS” rubric, the filling in of the input boxes activates the “SEND” key of the lower task bar, the actuation of which causes the CPDLC management window to return to its greeting display level with the display in the report field, of the message currently being transmitted on a background motif, in actual fact a green colored background, showing that it is active, of the local time, of the state of the transmission operation and of the countdown of the period granted for carrying out this transmission operation, with the display of the wording “MSG SENDING” in the auxiliary display field and with erasure of the action and parameterization selection field.

After transmission, the display of the message in the report field changes appearance. Its background motif, in fact the display background takes on a bright blue color locally, signifying that the dialog is closed, and the wording “MSG SENT” appears in the auxiliary display field. The actuation, finally, of the “CLOSE” button of the lower task bar makes it possible to archive the dialog relating to the message, this causing the message to be stored for possible consultation during a history search and the CPDLC window to resume its greeting display level with the appearance shown in FIG. 6.

The selection of the “DIRECT TO” request caption instead of the “SPEED” request caption also causes the CPDLC management window to switch to a parameterization display level but with the appearance of FIG. 20. Its action and parameterization selection field begins to display, under a banner recalling the caption of the activated rubric “REQUEST” and the kind of request chosen “DIRECT TO”, in addition to the “ADD MSG” activatable key 25 and the box 31 for inputting justificatory grounds preceded by the caption “DUE TO”, a box 32 for inputting the identity of the desired destination point preceded by the caption “POS” and a box 33 for inputting the coordinates of this destination point preceded by the caption “LAT/LONG”.

The two boxes 32, 33 for inputting the identity and coordinates of the desired destination point are tightly linked and filling one of them in may cause the other to be filled in automatically when the flight management computer of the aircraft has the point concerned in memory. The box 32 for inputting the identity of the desired destination point might not be filled in if the box 33 for inputting its coordinates is. The format for displaying the coordinates may be configurable depending on the preferences of the user companies, and likewise the destination point may be filled in automatically by synchronization with the flight management system of the aircraft.

Once parameterized, the “DIRECT TO” request is sent to the air traffic control ground station by actuation of the “SEND” key and archived once sent by means of the “CLOSE” key as is the case for all the reports and requests.

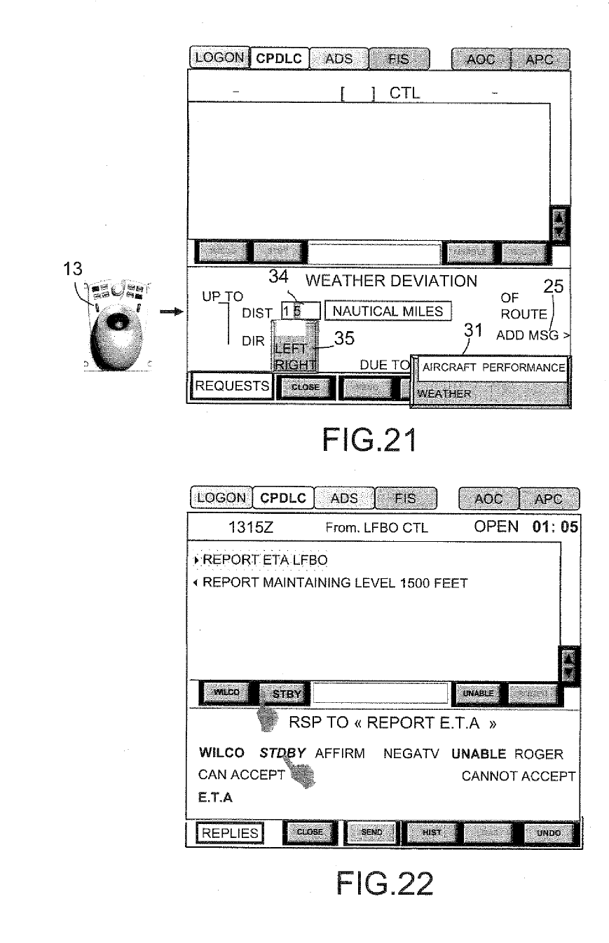

The selection of the “WEATHER DEVIATION” request caption instead of the “SPEED” or “DIRECT TO” request captions also causes the CPDLC management window to switch to a parameterization display level but with the appearance of FIG. 21. Its action and parameterization selection field begins to display, under a banner recalling the caption of the activated rubric “REQUEST” and the kind of request chosen “WEATHER DEVIATION”, in addition to the “ADD MSG” activatable key 25 and the box 31 for inputting justificatory grounds preceded by the caption “DUE TO”, a box 34 for inputting the amplitude of the diversion preceded by the caption “DIST” and followed by the distance unit used, and a box 35 for inputting the direction of the diversion preceded by the caption “DIR”. The two input boxes and their captions are framed by the captions “UP TO” and “OF ROUTE” that make it clearly apparent that a diversion is involved. The box 35 for inputting the direction of the diversion is a pop-up menu box comprising the captions “LEFT” and “RIGHT” and an empty caption allowing the crew to signal another direction.

Once parameterized, the “WEATHER DEVIATION” request is sent to the air traffic control ground station by actuation of the “SEND” key and archived once sent by means of the “CLOSE” key as is the case for all the reports and requests.

The various input boxes are arranged in the selection and parameterization field, in such a way as not to overlap and to be able to be assembled by overlapping so as to meet the input box requirements in the various parameterization situations that may arise.

To summarize, the CPDLC management window makes it possible, with its three display levels: greeting level, level for selecting types of action, report or request and level for parameterizing the actions, reports, replies and requests, to guide the crew of an aircraft step by step in their exchanges of messages with an air traffic control ground station. The use, for the displaying of the action, report, reply or request captions in the selection and parameterization field, of distinct colors depending on their prevailing properties: default action or message, licit or illicit action or message at this point in the processing as well as the use, for the displaying of the reports of actions and messages in the report field, of distinct display backgrounds depending on their states of processing: in progress, terminated but not archived, archived facilitate the work of the crew. Moreover, it introduces great flexibility into the management of the replies to the requests of an air traffic control ground station by virtue of its “STAND BY” keys which afford the possibility of placing the processing of a ground station request on standby so as to manage the messages on the basis of their relative importances rather than their ages.

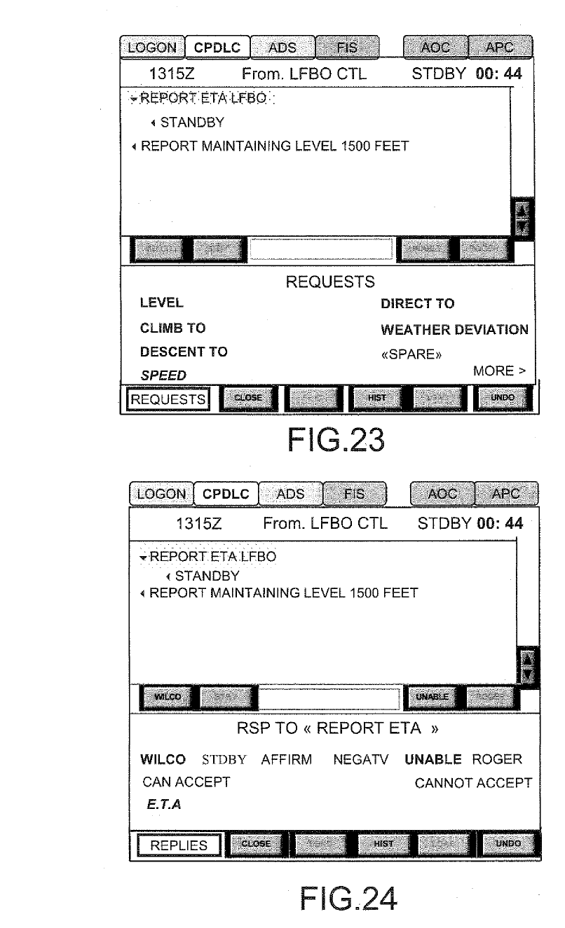

FIGS. 22 and 23 illustrate the effect of actuating the “STAND BY” key in the case where the air traffic control ground station makes a request for the estimated time to reach the position LFBO while the crew of the aircraft is in the process of sending a report for maintaining level at 1500 feet.

FIG. 22 shows the initial appearance of the CPDLC management window. After archiving the maintaining level report, the CPDLC management window switches to a display level for selecting actions in reply to the ground station request since this request has not been archived. Its report field displays the ground station request and the maintaining level report in the chronological order in which they appear. The ground station request appears on a background motif, in actual fact a green colored background showing that it is active and that the function keys appearing in the CPDLC window pertain thereto. The action and parameterization selection field is filled in, under the reply to message caption, with an inventory of standardized replies permitted in a messaging of the CPDLC service with, in bold but colored green in actual fact, the permitted replies which are the only ones to have any meaning in the present situation and in bold italics but in white on a green background, the default reply here “WILCO”. The crew of the aircraft may be satisfied with the default reply or modify it by activating another reply, here “STAND BY”, “UNABLE” or E.T.A. (the abbreviation of the English expression: “Estimated Time of Arrival”).

To defer its reply, the crew of the aircraft can actuate either the “STAND BY” caption of the action and parameterization selection field, the newly activated reply becoming the default reply, or the “STAND BY” key of the middle task bar. The “STAND BY” reply is sent automatically to the ground station with this wording in the left in the banner of the report field and while resetting the timer for counting down the time allowed for the reply to its maximum. The auxiliary display field signals the actual sending of the “STAND BY” reply by displaying the wording “MSG SENT”.

At this juncture, the crew may or may not archive the message by actuating the “CLOSE” key. FIG. 23 shows the appearance of the CPDLC management window while the crew of the aircraft has placed the message on stand by so as to send a request.

When the crew of the aircraft wishes to reply, assuming that they remain within the periods granted by the reply timer, they activate, if need be, the ground station request by selecting it in the report field of the CPDLC management window, thereby resetting the action and parameterization selection field to its state before the actuation of the “STAND BY” key as shown in FIG. 24. The crew of the aircraft can then respond to the request of the ground station in the same way as if a “STAND BY” key had not been actuated, the only difference being the wording of the reply “STAND BY” interposed between the request of the ground station and the actual reply of the aircraft's crew.

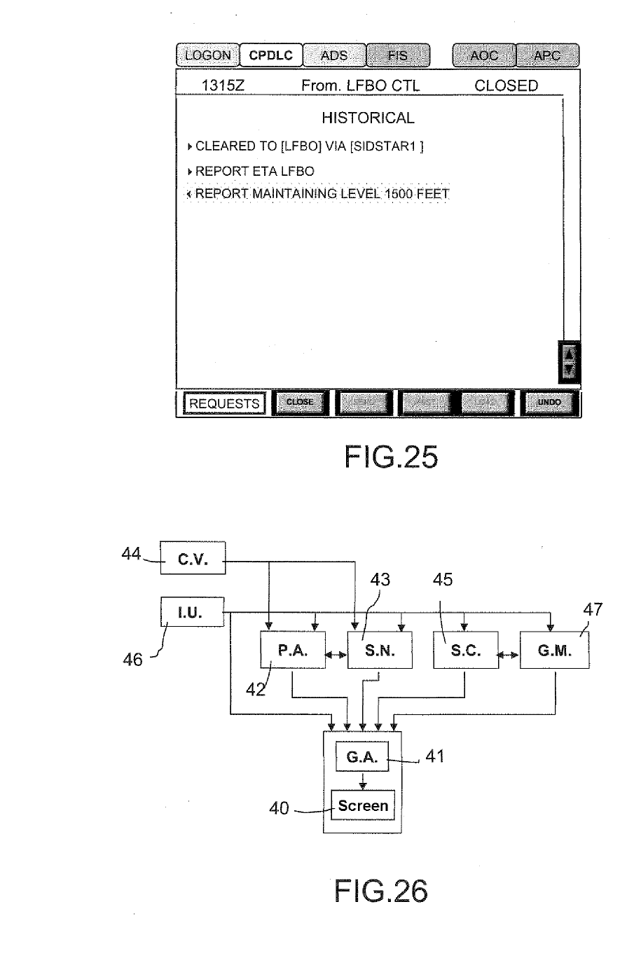

As shown in FIG. 25, the actuation of the “HIST” key of the lower task bar of the CPDLC management window causes the display, in forward or reverse chronological order, in the report field, under a banner captioned “HISTORICAL”, of all the messages stored and the exchanges to which they have given rise during the aircraft's mission. For this display, the report field takes the necessary dimensions, if need be by covering over the action and parameterization selection field and by spreading over several pages, the first page shown relating to the most recent messages. The active message, if it exists, is shown in a distinct guise: a local background with motif in FIG. 25, and, in actual fact a green colored local background.

The displaying of the various windows of the lower quadrant of the multifunction interactive screen MFD is the province of the display means of the device for managing the digital data exchanged by the aircraft represented, in FIG. 26, in its functional environment onboard an aircraft. This figure depicts a multifunction interactive display screen 40 with its display generator G.A. 41 receiving display instructions from various items of equipment including automatic piloting equipment P.A. 42 and a navigation system S.N. 43 that receives information about the aircraft's flight parameters provided by a set of sensors C.V. 44, an air-ground communication system S.C. 45 and a man/machine interface I.U. 46 controlling the movement and activation of a pointer over the multifunction display screen 40 and catering for the input of alphanumeric information bound for the various items of equipment. The digital data management device G.M. 47 and its display means use the services of the man/machine interface 46, exchange information with the air-ground communication system S.C. 45 and send display instructions to the multifunction interactive screen MFD 40 and to its display generator G.A. 41. As often onboard an aircraft, the exchanges of information and instructions between the various items of equipment involve a common data transmission bus which has not been represented.

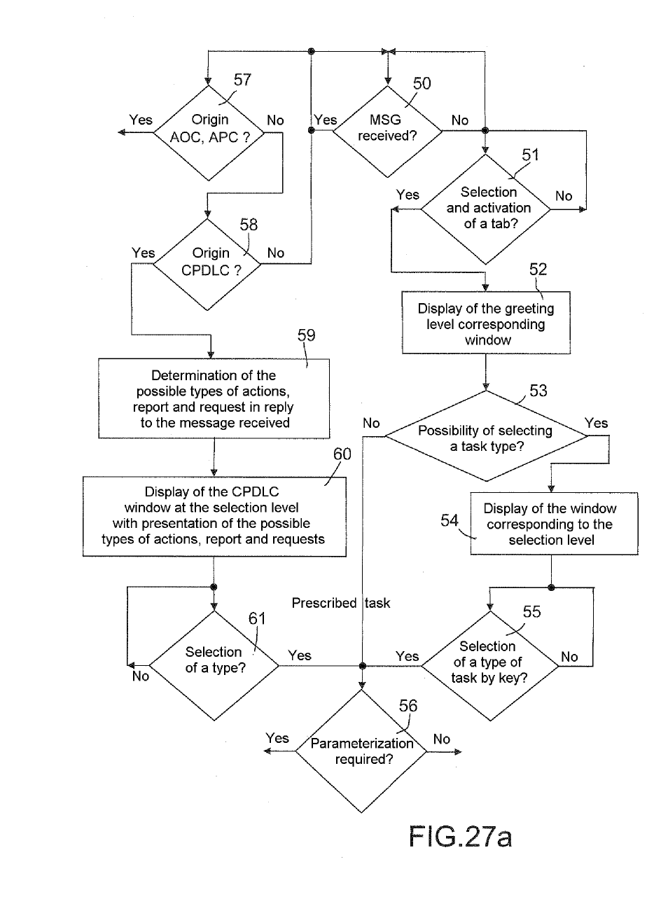

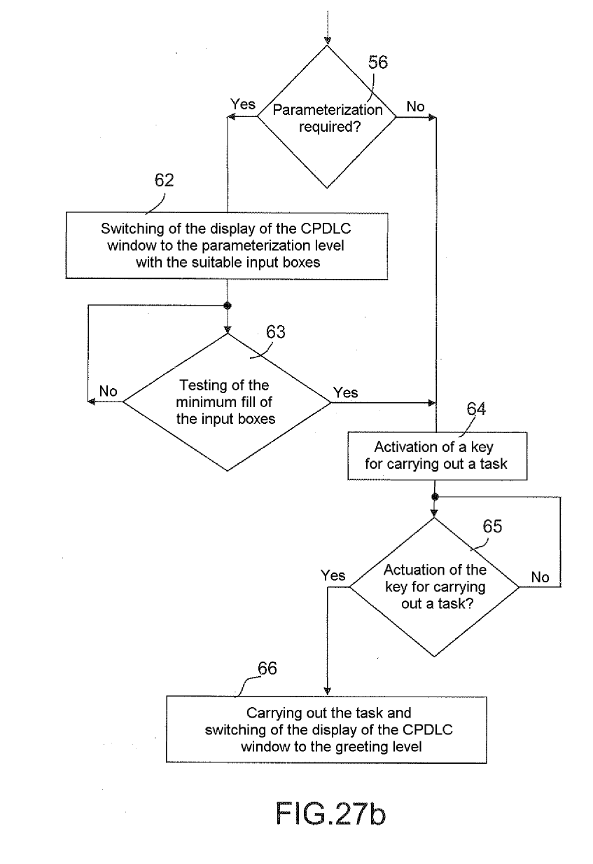

FIGS. 27a and 27b show an exemplary logic chart, the following of which enables the data management device and its display means to bring up the various management windows which have just been described on a multifunction interactive screen. According to this example, the data management device monitors, as a background task 50, the possible receipt of a message.

In the absence of any message received, the data management device sends the interactive multifunction screen, by way of its display means, the instruction to display by default the CPDLC management window at its greeting level (FIG. 6) and monitors at 51 the selection and activation of an interactive tab of row a. When it detects the activation of a tab, it determines at 52 the service concerned and sends the multifunction interactive display screen the instruction to bring up the management window corresponding to the greeting display level. At 53 it investigates whether the service concerned allows a choice between various types of task. If the service called by the interactive tab allows a choice between various types of task, it sends, at 54, the multifunction interactive screen the instruction to display the management window corresponding to the selection display level and monitors at 55 the selection by key of a task type. If the service called by the interactive tab permits only one type of task or if a task type has been keyed in at 55, the data management device investigates at 56 whether the type of task to be performed requires parameterization.

After detection of the receipt of a message at 50, the data management device investigates at 57 the affiliation of the message received to an AOC or APC service relating to the charter company or passengers. If such an affiliation is found, it enters processing loops, not represented since they are very similar to those pertaining to the CPDLC service that have just been detailed. If the message received is not affiliated either with the AOC service or with the APC service, the data management device investigates at 58 affiliation to the CPDLC service. If the service to which the message received is affiliated is not the CPDLC service either, the data management device considers that the message received does not require any reply on the part of the crew and stops processing it at this juncture.

If the data management device finds at 58 that the message received is affiliated with the CPDLC service, it determines at 59 the various types of actions, report and request that are possible in reply, sends at 60, to the multifunction interactive screen, the instruction to bring up the CPDLC management window at the selection display level with presentation, in its selection and parameterization field, of the various possible types of actions, reply, report and request, and monitors at 61 the selection by key of a type of action, reply, report or request. After keying in a type of action, reply, report or request, the data management device investigates at 56 whether the type of action, reply, report or request keyed in requires parameterization, the various branches of the logic chart executed joining up at this level.

As shown in FIG. 27b, if the type of task, action, reply, report or request, selected by key or representing the only possibility at the time, requires parameterization, the data management device sends at 62, to the multifunction interactive screen, an instruction to bring up the CPDLC management window at the parameterization display level with the suitable input boxes and tests at 63 the minimum fill of the input boxes permitting the activation of at least one key for carrying out a task.

As soon as the fill test at 63 is satisfied or in the absence at 56 of any need for parameterization, the data management device activates at 64 at least one key for carrying out a task appearing in the displayed version of the CPDLC management window, monitors at 65 the actuation of an activated key for carrying out a task and sends at 66, to the multifunction interactive screen, an instruction to bring up the CPDLC management window at the greeting display level.

1. An onboard device for managing the digital data exchanged, without vocal step, by an aircraft, with the ground or other aircraft within specialized services, comprising means for display on an auxiliary quadrant of an interactive screen associated with a pointing and alphanumeric data input device in the manner of the screen of a computer terminal, the display surface of said interactive screen being split into several quadrants of which the main ones are assigned to the primary flight parameters and to a navigation map and said display means showing, in an auxiliary quadrant of the interactive screen and in overlaid planes, various management windows assigned, in the one case to the management of an air-ground link intended to convey the data with the ground and, in the case of each of the other management windows to a different specialized service and a tab-based selection system, the tabs of which are always visible in the foreground, allowing any one of the management windows to be selected and placed in the foreground by means of the pointing and input device.

2. The device as claimed in claim 1, wherein the display means configures management windows with three successive display levels:
a greeting level where the window considered presents various task types that may be envisaged,
a level for selecting types of action and report, request or response message that may be envisaged for accomplishing a task type selected beforehand, and
a level for parametrizing an action and report, request or response message selected beforehand.

3. The device as claimed in claim 1, wherein the display means splits the management windows horizontally into two information fields: an upper information field reserved for the action and message reports, and a lower information field reserved for the selection, preparation and parametrization of an action and report, response or request message.

4. The device as claimed in claim 1, wherein the display means configures the management windows with, at their base, a lower horizontal task bar comprising activated or unactivated actuation buttons depending on the prevailing licitness of the tasks that they govern.

5. The device as claimed in claim 4, wherein the lower horizontal task bar comprises an actuation button triggering the execution of a task of displaying the journal of the actions and messages processed from a mission start.

6. The device as claimed in claim 4, wherein the lower horizontal task bar furthermore comprises at least one pop-up menu with rubrics activated as a function of the prevailing licitness of the tasks to which they relate.

7. The device as claimed in claim 3, wherein the display means configures the management windows with two horizontal task bars: a first lower horizontal task bar placed at the base of the windows and a second middle horizontal task bar placed at the limit of the report field and of the selection, preparation and parametrization field, said horizontal task bars comprising activated or unactivated actuation buttons depending on the prevailing licitness of the tasks that the two horizontal task bars govern.

8. The device as claimed in claim 3, wherein the display means configure the management windows additionally with an auxiliary information field recalling the last task performed or the next task to be performed.

9. The device as claimed in claim 3 wherein the display means site the auxiliary information field level with the middle horizontal task bar.

10. The device as claimed in claim 3, wherein the display means depict the action and message reports in the report field in different guises depending on their prevailing processing states: in progress, terminated or archived.

11. The device as claimed in claim 10, wherein the display means depict the action and message reports in the report field on local display backgrounds of different colors depending on their prevailing processing states: in progress, terminated or archived.

12. The device as claimed in claim 3, wherein the display means depict, in the selection, preparation and parametrization field of a management window placed at selection display level, a gamut of action and report, response or request message captions suitable for a task type selected beforehand at the greeting level or ensuing from the greeting level when the latter authorizes only a single task.

13. The device as claimed in claim 12, wherein the display means depict the action and report, response and request message captions in the selection, preparation and parametrization field in different guises depending on their prevailing properties: default action or message, licit action or message at this point in the processing, illicit action or message at this point in the processing.

14. The device as claimed in claim 13, wherein the display means depict the action and report, response and request message captions in the selection, preparation and parametrization field as entries of different colors depending on their prevailing properties: default action or message, licit action or message at this point in the processing, illicit action or message at this point in the processing.

15. The device as claimed in claim 3, wherein the display means depict in the selection, preparation and parametrization field of a management window placed at the parametrization display level, at least one alphanumeric data input box appropriate to the parametrization of a report, response or request message selected beforehand at the selection display level or ensuing from the greeting level when the latter authorizes only the preparation and dispatch of a message.

16. The device as claimed in claim 15, wherein said input box or boxes appearing in the selection, preparation and parametrization field of a management window placed at the parametrization display level are accompanied by captions defining their contents.

17. The device as claimed in claim 15, wherein the various input boxes appearing in the selection, preparation and parametrization field of a management window when processing the set of tasks to which the relevant window gives access are placed at different positions in the selection, preparation and parametrization field so as not to overlap and to be able to be assembled by overlaying to satisfy the prevailing input box requirements.

18. The device as claimed in claim 3, wherein the display means depict a mission licence as report field caption.

19. The device as claimed in claim 3, wherein the display means depict, during the processing of a response to a message, a timer counting down a delay granted for the response, as report field caption.

20. The device as claimed in claim 3, wherein the display means depict a rubric recalling the task currently being executed as selection, preparation and parametrization field caption.

21. The device as claimed in claim 7, wherein the display means site the auxiliary information field level with the middle horizontal task bar.
